(19) United States
(12) Patent Application Publication
(10) Pub. No.: US 2009/0217767 A1
(43) Pub. Date: Sep. 3, 2009

(54) Measurement of Stress in Coatings Using a Piezoelectric Actuator

(75) Inventor: Ruediger Scherschlicht, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: RODENSTOCK GHMBH, MUENCHEN (DE)

(21) Appl. No.: 12/093,573

(22) PCT Filed: Nov. 14, 2006
(86) PCT No.: PCT/EP06/10925

§ 371 Date: Oct. 9, 2008

(30) Foreign Application Priority Data
Nov. 14, 2005 (DE) 10-2005-054-193.3

(51) Int. Cl. G01B 7/16

(52) U.S. Cl. 73/779; 73/780; 73/774

(57) ABSTRACT

Device and method for determining mechanical stresses in a substrate coating has a substrate holder and actuating element configured as a piezoelectric actuator moveable at least partially in relation to the holed. The actuating element mechanically prestresses the substrate by applying an electric starting voltage to the piezoelectric actuator to cause the actuating element to be partially displacement by a predetermined and/or determinable starting displacement relative to the holed. A coating is applied to a deposition area of the substrates and a change in displacement of the actuating element is determined.

The present invention relates to a method and a device for determining mechanical stresses in a coating of a substrate.

Especially in the production of optical lenses and, therefore, above all, in the surface treatment of spectacle lenses, coatings are a crucial factor. Suitable functional coatings of spectacle lenses may significantly improve both their optical as well as their mechanical properties and/or enable these optical and mechanical properties to be adapted to the requirements. In particular, these coatings can be used to optimize the reflection properties on the surfaces and/or at the interfaces of lenses. Moreover, these coatings may also be used to improve the mechanical properties and, in particular, the scratch resistance of lens surfaces.

One characteristic of such coatings is that the material of the coating is normally different from the material of the substrate—thus, in particular, different from the material of the main body of the lens. Hence, the mechanical, thermal and optical properties of the coating are often so remarkably different that from the onset it cannot be guaranteed that such a coating can be deposited without forming undesired cracks on the substrate. Furthermore, it is very likely that such cracks will have a definite negative impact on the optical properties or the protective effect of the coating. Therefore, it is necessary to be able to control the deposition of such coatings in such a manner that such undesired effects are avoided.

In order to control and to check the deposition of such coatings, it is often mandatory or at least very helpful to acquire information about the internal mechanical stresses within a coating. At the same time it is especially desirable to be able to measure (in situ) the mechanical stresses and, in particular, the lateral stresses within the coating as early as during the deposition process.

To date the most useful method has been to measure the deformation of strain plates. In this case the deformation is measured after the entire coating has been applied (ex situ). This method is often error prone and inaccurate owing to the relaxation processes and the influences of the measurement process on the results.

Another method is based on an optical path length measurement. In this case a laser beam impinges on the rear side of a reflecting test plate. The front side of this test plate is coated. The coating deforms owing to the film stresses in the plate. This deformation deflects the laser beam like a pointer; and the distance between the quiescent position and the deposited position reproduces the stress in the coating on the test plate. This method is technically very complicated, cannot be employed everywhere and under some circumstances error prone. However, in contrast to the first described method it offers the possibility of an “in situ” measurement. A commensurate test method is commercially available from Sigma-Physik. However, its implementation in existing film deposition systems is technically complicated and not always possible.

Therefore, the object of the present invention is to provide a method and a device, both of which enable an “in situ” measurement of mechanical stresses in coatings and can be integrated with low technical complexity into existing film deposition systems.

This object is achieved with a method, exhibiting the features disclosed in claim 1, and with a device, exhibiting the features disclosed in claim 11.

Therefore, the present invention provides a method, which is intended for determining the mechanical stresses in a coating of a substrate and which comprises the following steps:
arranging the substrate on at least one holder and on at least one actuating element, which can be moved at least partially in relation to the holder, the actuating element comprising a piezoelectric actuator,
using the actuating element to mechanically prestress the substrate by applying an electric starting voltage Vₒ to the piezoelectric actuator in such a manner that the piezoelectric actuator causes the actuator element to be partially deflected by a predetermined and/or determinable starting displacement Lₒ relative to the holder;
applying at least one part of the coating to at least one deposition area of the substrate;
determining a change ΔL in the deflection of the actuating element using a sensor element, in particular a position sensor.

Preferably an essentially two dimensional substrate and particularly preferred an essentially planar substrate—for example, in the form of a plate—is used as the substrate. That is, the expansion of the substrate is essentially smaller in one spatial direction than in the two other spatial directions. However, in principle, the inventive method can also be applied to thicker substrates.

Especially if a thin, essentially two dimensional substrate, such as a plate, a disk or a lens, is used, the substrate is arranged preferably in the area of its outer edge on the holder and in a central area on the actuating element. Particularly preferred the actuating element abuts a single contact point on the substrate, whereas the substrate is supported by the holder at several points and/or in a larger area. In this case the substrate could be clamped into the holder or preferably could be pressed against the holder by means of the actuating element.

By applying an electric voltage to the piezoelectric actuator of the actuating element, the piezoelectric effect in the piezoelectric actuator causes the actuating element to be moved at least to some extent in relation to the holder. Thus, the actuating element and, in particular, the contact point experience at least to some extent a deflection against its quiescent position in relation to the holder. At the same time a mechanical stress is exerted on the substrate. Preferably in this case the substrate and, in particular, a surface of the substrate—the deposition area—that is provided for the deposition of a coating, is deformed and/or dislocated. Especially preferred the actuating element and, in particular, the contact point are displaced at least to some extent in a direction vertically to the deposition area. Therefore, it is, most of all, preferred that the prestressing causes a deposition area, which was essentially planar beforehand, to experience an essentially convex curvature.

Following the mechanical prestressing, at least one part of the coating is applied to at least one part of the deposition area of the substrate. Depending on the type of coating, the deposition process is carried out preferably in a conventional process step—for example, by means of evaporation and/or by means of a specific epitaxy process. It is especially preferred that the step of depositing at least one part of the coating takes place at low ambient pressure, which is, therefore, reduced especially in relation to the atmospheric pressure, most of all preferably at high vacuum or at ultra-high vacuum.

The mechanical stresses and, in particular, the lateral tensile and/or compressive strains that may develop in the coating are transferred via the deposition area to the substrate. The result is a change in the total mechanical stress in the system, comprising substrate and coating, in relation to the mechanical prestress of the substrate. In particular the force, acting between the actuating element and the substrate changes. Depending on the type of mechanical stress in the coating, the force between the actuating element and the substrate—thus, in particular, the compressive force, acting at the contact point, —becomes either larger or smaller than prior to the application of the coating. The result is a change in the displacement of the actuating element owing to the elastic effects that develop in each material and, in particular, also in the actuating element and the piezoelectric actuator. This change in the deflection is registered by means of the sensor element. Depending on whether a positive or negative change ΔL in the deflection is registered, it is possible to conclude whether the coating exhibits a tensile or compressive strain. If no change in the deflection is registered (ΔL=0), it indicates preferably a coating that is stress-free.

In a preferred embodiment not only the sign of the change in deflection but also its numerical value is determined. This procedure is equivalent to a first preferred process mode, where in the event of a constant electric voltage at the piezoelectric actuator the mechanical stress in the coating is determined on the basis of the change ΔL in deflection.

In order to be able to register even very low mechanical stresses in the coating, the sensor element is preferably sensitive enough to be able to register even small changes ΔL in the deflection. Preferably the sensor element can register changes ΔL of less than 100 nm, even more preferred less than 10 nm, most of all preferred less than 1 nm.

Preferably the sensor element is integrated into the actuating element. In this case it is especially preferred that the sensor element and the piezoelectric actuator are constructed as one unit. In particular, in this case a commercially available piezoelectric actuator with an integrated sensor element can be installed. Therefore, the method comprises preferably the step of determining a change ΔL in the displacement of the actuating element using a sensor element that is integrated into the actuating element. Preferably the sensor element comprises a capacitive sensor and/or an inductive sensor and/or a resistive sensor. Hence, the step of determining a change ΔL in the displacement of the actuating element comprises preferably a step of determining a change in the capacitance of a capacitive sensor and/or a step of determining a change in an inductance of an inductive sensor and/or a step of determining a change in an electric resistance of a resistive sensor. Such electrically readable sensors permit an especially simple electronic evaluation of the measured values. In this context wire strain gauges, whose electric resistance is a function of their mechanical stretching and/or stress, are, in particular, very good as the resistive sensors. Such sensors allow preferably a measurement accuracy of ΔL<1 nm. Even higher measurement accuracy of preferably ΔL<0.1 nm can be achieved, in particular, with the use of capacitive position sensors.

The starting deflection Lₒ is selected preferably in such a manner that, on the one hand, it is possible to detect with maximum sensitivity the change ΔL in the deflection and, thus, the mechanical stress in the coating; and, on the other hand, the mechanical properties and, in particular, the elastic forces and the surface properties of the substrate are not significantly changed by the mechanical prestresses. In particular, it is to be avoided that the prestress process of the substrate causes a significant change in the deposition evolution and, in particular, in the mechanical stress evolution in the coating. The mechanical prestressing of the substrate ought to evolve at least to the extent that even in the event of a change ΔL in the deflection that is detectable by means of the sensor element a reliable contact between the actuating element and the substrate is still maintained. It is especially preferred that the substrate is deflected by a few 10 μm to approximately 100 μm, especially at the contact point.

In this way the inventive method permits the mechanical stresses in a coating of a substrate to be determined during the deposition process of the coating (in situ). In addition, this process can be easily integrated into existing process operations of conventional deposition methods.

After the step of determining a change in the deflection, the method comprises preferably, in addition, the steps:
readjusting the electric voltage at the piezoelectric actuator in such a manner that the deflection of the actuating element is equivalent again to the starting deflection Lₒ;
determining an electric voltage difference ΔV between the readjusted electric voltage and the electric starting voltage Vₒ.

Thus, the electric voltage at the piezoelectric actuator is readjusted preferably in such a manner that thereafter it holds in essence: ΔL=0. In this case the determined electric voltage difference ΔV is a measure for the mechanical stress in the coating. In a preferred embodiment not only the sign of the voltage difference, but also its numerical value is determined. Thus, this procedure is equivalent to a second preferred process mode, where in the event of an essentially constant deflection Lₒ of the actuating element the mechanical stress in the coating is determined on the basis of the change ΔV in the electric voltage applied to the piezoelectric actuator.

In addition, the method comprises preferably a step of determining a value of the mechanical stress in the coating that is applied
from the determined value of the change ΔL in the displacement of the actuating element and/or
from the determined value of the electric voltage difference ΔV.

Furthermore, it is preferred that during the step of applying the coating
the change ΔL in the displacement of the actuating element and/or
the electric voltage difference ΔV and/or
the determined value of the mechanical stress in the coating
   is/are determined multiple times in succession.

To this end, the process of applying the coating can be temporarily interrupted during the measurement and/or determination of the respective value. However, it is preferred that the respective value is measured and/or determined without interrupting the deposition process that is essentially continuous.

It is especially preferred that the deflection values and/or voltage values are measured and/or determined in essence continuously.

Preferably the electric voltage at the piezoelectric actuator is readjusted by means of a regulating unit in such a manner that the displacement of the actuating element and, thus, preferably the deflection of the substrate at the contact point during the application of the coating remains in essence constant at the value of the starting deflection Lₒ.

In a preferred embodiment of a method, according to the present invention, the course
of the change ΔL in the displacement of the actuating element and/or
of the electric voltage difference ΔV and/or
of the determined value of the mechanical stress in the coating
   is recorded as a function of the time and/or the applied thickness of the coating and is stored preferably on a data carrier.

Preferably a spectacle lens is used as the substrate. As an alternative, a test substrate may also be used. In this case the test substrate is made in essence of the same material as the substrate, on which the coating is to be applied in the end effect. Therefore, the test substrate may be made, in particular, in such a manner that an especially sensitive detection of the stresses that evolve in the coating can ensue.

In addition, the present invention provides a device, which is intended for determining mechanical stresses in a coating of a substrate and which comprises
at least one substrate holder for supporting the substrate,
an actuating element, which comprises a piezoelectric actuator, which causes the actuating element to be moved at least to some extent by a displacement relative to the substrate holder by applying a predetermined and/or determinable electric voltage to the piezoelectric actuator in such a manner that a mechanical prestress and/or deformation and/or dislocation of the substrate, secured on the substrate holder, is effected,
a sensor element, which is integrated preferably into the actuating element and which is designed to detect a change in the displacement of the actuating element and to emit a sensor signal as a function of the detected change in deflection.

Preferably the sensor element and the piezoelectric actuator are constructed as one unit. In this case it is especially preferred that a commercially available piezoelectric actuator with an integrated sensor element can be installed. The sensor element comprises preferably a capacitive sensor and/or an inductive sensor and/or a resistive sensor.

In addition, the device comprises preferably voltage sensing means for sensing the electric voltage applied and/or being applied to the piezoelectric actuator.

In a preferred embodiment the device comprises additionally a control unit, which is designed to receive the sensor signal, emitted by the sensor element, and to control the electric voltage, which is applied to the piezoelectric actuator, as a function of the received sensor signal. It is especially preferred that the control unit comprises a regulating unit, which is designed to regulate, as a function of the received sensor signal, the electric voltage, applied to the piezoelectric actuator, in such a manner that the deflection of the actuating element remains in essence constant. That is, a detected change in the deflection is immediately compensated by a corresponding change in the electric voltage.

In addition, the device comprises preferably a voltage evaluating device, which is designed to receive
the sensor signal and/or
the value of the voltage, applied to the piezoelectric actuator, and/or the change in voltage and to determine, as a function thereof, a value of the mechanical stress in the coating.

It is especially preferred that the device comprises, in addition, a storage device, which is designed to receive
the sensor signal and/or the displacement L and/or the change in displacement Lₒ of the actuating element and/or
the value of the voltage, applied to the piezoelectric actuator, and/or the change in voltage and/or
the value of the mechanical stress in the coating
   and to store its temporal course in a storage medium.

In an especially preferred embodiment the device exhibits, in addition, a film deposition system.

Thus, the present invention proposes from another perspective the application of a piezoelectric actuator with a position sensor element for measuring the mechanical stresses in a coating of a substrate. In particular, the piezoelectric actuator is provided preferably in a device, which is provided according to the present invention, and is used preferably in accordance with a method provided by the invention.

The invention is described below by means of one example with reference to the accompanying drawings of preferred embodiments.

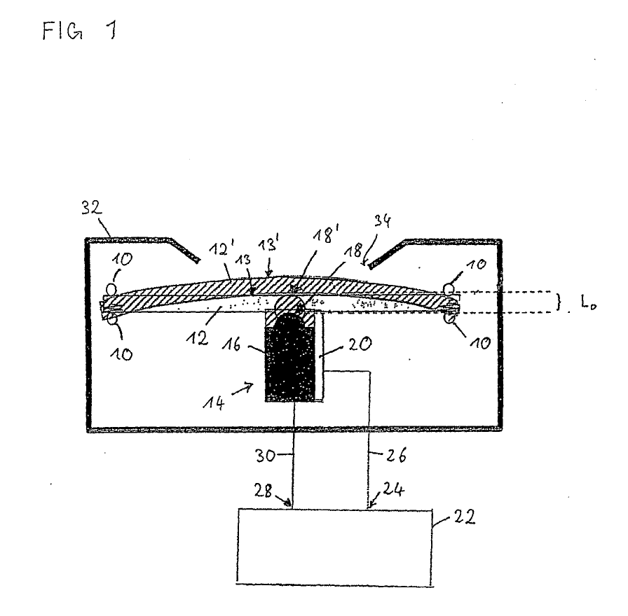

FIG. 1 depicts a preferred embodiment of a device, according to the present invention.

FIG. 1 depicts a preferred embodiment of a device, according to the present invention. Furthermore, a preferred method of the invention is described by means of this device. In the illustrated embodiment the device comprises a holder or rather a substrate holder 10, which comprises, in particular, four holding elements. A substrate 12 is disposed on the holder 10 and is firmly held or rather fixed on the outer edge, in particular, by means of the holding elements of the holder 10. The present example shows a disk or rather a plate having an essentially constant thickness as the substrate 12. In the relaxed state this plate exhibits at least two essentially plane parallel surfaces. In the relaxed state the substrate 12 exhibits, in particular, an essentially planar disposition area 13.

In addition, the device comprises an actuating element 14, which is used as a voltage regulated pressure sensor. The voltage regulated pressure sensor 14 or rather the actuating element 14 comprises a piezoelectric actuator 16 as an essential component. In particular, a piezoelectric crystal is used as the piezoelectric actuator 16. Applying an electric field or rather an electric voltage causes this piezoelectric crystal to expand or to contract in at least one spatial direction. The actuating element 14 and, in particular, the piezoelectric actuator 16 makes contact with the substrate 12 by way of a contact point 18. By applying an electric voltage and/or an electric field to the piezoelectric actuator 16, its spatial expansion in the direction of the substrate 12 causes a displacement L₀ of the contact point 18 to a new position, which is shown as the contact point 18′ in FIG. 1. At the same time this displacement of the actuating element 14 also causes the substrate 12 to deflect to some extent, thus prestressing the substrate 12, a feature that is graphically rendered by the prestressed substrate 12′ in FIG. 1 (shown as a shaded area in FIG. 1). As a result, the essentially planar disposition area 13 becomes a convex curved deposition area 13′.

In addition, the device comprises a sensor element 20. In the illustrated embodiment the sensor element 20 is integrated as a wire strain gauge into the actuating element 14 and is constructed, in particular, together with the piezoelectric actuator 16, as one unit. Since the piezoelectric actuator 16 expands upon applying an electric voltage and/or an electric field, the wire strain gauge 20 also stretches, as a result of which its electric resistance changes. This change in resistance can be detected and constitutes a measure for the displacement Lₒ.

A regulating unit or rather a control unit 22 exhibits a sensor signal input 24, by means of which a sensor signal 26 from the sensor element 20 is received. This sensor signal could be, in particular, a measure for the electric resistance of the wire strain gauge 20. In addition, the control unit or rather the regulating unit 22 exhibits a voltage output 28, by means of which it can emit an electric voltage to the piezoelectric actuator 16.

In addition, the illustrated device has a shield 32, which defines a deposition window 34. As a result, an area of the deposition area 13′ is defined, on which a coating can be applied to the substrate 12′ by means, for example, of evaporation or an epitaxy process. If at this stage the coating deposited on the deposition area 13′, exhibits, in particular, lateral tensile and/or compressive strains, then these strains are also transferred to the substrate 12′ and thereby cause a change in the compressive force at the contact point 18′ on the voltage regulated pressure sensor or rather the actuating element 14. This modified compressive force effects a change in the displacement of the actuating element 14. The sensor element 20 detects this change and transfers the corresponding sensor signal 26 to the control unit 22. The control unit or rather the regulating unit 22 is designed preferably as the voltage evaluating device and determines the actual mechanical stress in the coating on the basis of the received sensor signal 26. In this first operating mode the voltage applied to the piezoelectric actuator 16 can be held constant.

In a second alternative operating mode the regulating unit 22 regulates by means of the outputted electric voltage 30 the electric field or rather the electric voltage that is applied to the piezoelectric actuator 16 in such a manner that the displacement of the actuating element 14 returns again into its original starting displacement Lₒ. Therefore, the required voltage V or rather the required change in voltage ΔV is a measure for the mechanical stress evolving in the coating. Preferably the voltage evaluating device is designed to determine the actual mechanical stress in the coating on the basis of this change in the electric voltage.

The present invention can be utilized not only in connection with spectacle lenses, but also for coating a plurality of additional optical components, like lenses, mirrors or prisms, and also for coating and/or painting metal substances, such as for anti-corrosion coatings. 6 Moreover, the method and the inventive device are not limited to the explicitly mentioned deposition method, but rather can be used with many other deposition methods that are known to the person skilled in the art.

### LIST OF REFERENCE NUMERALS

10 substrate holder
12 substrate
12′ prestressed substrate
13, 13′ deposition area
14 actuating element; voltage regulated pressure sensor
16 piezoelectric actuator
18, 18′ contact point
20 sensor element
22 control unit; regulating unit; voltage evaluating device
24 sensor signal input
26 sensor signal
28 voltage output
30 electric voltage
32 shield
34 deposition window
Lₒ starting deflection

1.-19. (canceled)

20. Method for determining mechanical stresses in a coating of a substrate, comprising
(a) arranging the substrate on at least one holder and on at least one actuating element comprising that is a piezoelectric actuator moveable at least partially in relation to the holder;
(b) using the actuating element to mechanically prestress the substrate by applying an electric starting voltage to the piezoelectric actuator so that the piezoelectric actuator causes the actuating element to be partially displaced by a predetermined and/or determinable starting displacement relative to the holder;
(c) applying at least one part of the coating to at least one deposition area of the substrate; and
(d) determining a change in displacement of the actuating element using a sensor element.

21. Method, as claimed in claim 20, further comprising
(e) readjusting the electric voltage at the actuating element so that the displacement of the actuating element is equivalent again to the starting displacement; and
(f) determining an electric voltage difference between the readjusted electric voltage and the electric starting voltage.

22. Method as claimed in claim 21, further comprising
(g) determining a value of the mechanical stress in the coating that is applied from at least one of the determined value of the change in the displacement of the actuating element and the determined value of the electric voltage difference.

23. Method as claimed in claim 22, wherein, during the applying of the coating at least one of the change in the displacement of the actuating element, the electric voltage difference and the determined value of the mechanical stress in the coating are determined multiple times in succession.

24. Method as claimed in claim 22, wherein a course of the change in at least one of the displacement of the actuating element, the electric voltage difference and the determined value of the mechanical stress in the coating is recorded as a function of the time and/or the applied thickness of the coating.

25. Method as claimed in claim 20, wherein readjustment of the electric voltage at the actuating element is effected by a regulating unit so that the displacement of the actuating element during the application of the coating remains substantiality constant at a value of the starting displacement.

26. Method as claimed in claim 20, wherein the substrate is a spectacle lens.

27. Method as claimed in claim 20, wherein the sensor element is integrated into the actuating element.

28. Method as claimed in claim 20, wherein the sensor element comprises at least one of a capacitive sensor, an inductive sensor and a resistive sensor.

29. Method as claimed in claim 20, wherein depositing at least one part of the coating takes place at low ambient pressure.

30. Device for determining mechanical stresses in a coating of a substrate, comprising
at least one substrate holder for the substrate,
an actuating element comprising a piezoelectric actuator and configured to cause the actuating element to be moved at least partially by a displacement relative to the substrate holder upon application of a predetermined and/or determinable electric voltage to the piezoelectric actuator to effect a mechanical prestress of the substrate when secured on the substrate holder; and
a sensor element configured to detect a change in displacement of the actuating element and to emit a sensor signal as a function of the detected change in deflection.

31. Device as claimed in claim 30, further comprising a sensor to sense the electric voltage applied to the actuating element.

32. Device as claimed in claim 30, further comprising a control unit configured to receive the sensor signal emitted by the sensor element and to control the electric voltage that is applied to the actuating element as a function of the received sensor signal.

33. Device as claimed in claim 32, wherein the control unit is configured to regulate, as a function of the received sensor signal the electric voltage applied to the actuating element so that the displacement of the actuating element remains substantially constant.

34. Device as claimed in claim 30, further comprising a voltage evaluating device configured to receive at least one of the sensor signal, the value of the voltage applied to the piezoelectric actuator and the change in voltage, and to determine, as a function thereof, a value of mechanical stress in the coating.

35. Device as claimed in claim 30, further comprising a storage device configured to receive at least one of the displacement and the change in displacement of the actuating element, the value of the voltage applied to the piezoelectric actuator and/or the change in voltage, and the value of the mechanical stress in the coating, and to store a temporal course thereof in a storage medium.

36. Device as claimed in claim 30, wherein the sensor element is integrated into the actuating element.

37. Device as claimed in claim 30, further comprising a film deposition system.

38. Device as claimed in claim 30, wherein the sensor element comprises at least one of a capacitive sensor, an inductive sensor and a resistive sensor.
